(19) United States
(12) Patent Application Publication
(10) Pub. No.: US 2019/0193100 A1
(43) Pub. Date: Jun. 27, 2019

(54) METERING DEVICE AND METERING METHOD

(71) Applicant: Primetals Technologies Austria GmbH, Linz (AT)

(72) Inventors: Paul Felix DOLLHÄUBL, Zwettl an der Rodl (AT); Gregor GERSTORFER, Linz (AT); Gernot STELZER, Luftenberg (AT); Thomas STEPANEK, Wien (AT)

(21) Appl. No.: 16/099,474

(22) PCT Filed: May 24, 2017
(86) PCT No.: PCT/EP2017/062603

§ 371 Date: Nov. 7, 2018

(30) Foreign Application Priority Data
May 30, 2016 (EP) 16171963.8

(51) Int. Cl. B05B 12/14; B05B 15/55; B05B 7/32; B05B 9/04

(52) U.S. Cl. CPC B05B 12/1418; B05B 15/55; B05B 9/0423; B05B 9/0413; B05B 7/32

(57) ABSTRACT

A metering device (4, 82, 96) for metering a fluid includes a common supply line (6) and multiple discharge lines (20). To improve the metering process, the metering device (4, 82, 96) includes multiple delivery devices (18) each having a cavity (24) for receiving the fluid and a piston (26) for displacing the fluid, wherein each of the multiple delivery devices (18) is connected on the inlet side to the common supply line (6) and is connected on the outlet side to one of the multiple discharge lines (20).

### CROSS-REFERENCE TO RELATED APPLICATIONS

The present application is a 35 U.S.C. §§ 371 national phase conversion of PCT/EP2017/062603, filed May 24, 2017, which claims priority of European Patent Application No. 16171963.8, filed May 30, 2016, the contents of which are incorporated by reference herein. The PCT International Application was published in the German language.

### TECHNICAL FIELD

The invention relates to a metering device for metering a fluid, comprising a common supply line and a plurality of discharge lines.

### TECHNICAL BACKGROUND

The metering of fluids plays an important part in many various application sectors when specific quantities of a fluid are required. Metering is generally understood to be measuring or assessing a specific quantity. For example, specific quantities of lubricant are required in a rolling mill, so that the lubricant is metered. The required quantity of lubricant is presently conveyed by a pump in a rolling mill. That quantity then is distributed among a plurality of nozzles. The nozzles then spray the lubricant onto the rollers of the rolling mill, or into a roller gap of the rolling mill, respectively.

The lubricant herein can be sprayed in its pure form or else as a mixture with a carrier medium. When it is sprayed as a mixture, the lubricant can be mixed with the carrier medium already prior to passing the pump, or the lubricant is mixed with the carrier medium only in the nozzle. All variants of spraying have in common that the quantity of lubricant used is to be precisely metered. If too little lubricant is used, increased wear arises on the rollers and an increase in the energy required in the rolling procedure in the rolling mill arises. In order for inaccuracies in the metering by way of a conventional pump to be equalized, more lubricant than is absolutely required is presently used. This is at the expense of lower operating costs and/or representing a risk to the rolling process because issues relating to grip can arise on account of the reduced friction in the rolling gap.

A lubricating system having a common supply line and at least one conveying device is shown in document WO 2010/085489 A1. A specific quantity of lubricant is guided to a machine injection point by means of the lubricating system. In order for the flow of lubricant to be able to be precisely monitored, the lubricant system comprises an infeed pump which on the discharge side is connected to the supply line, and a throughflow measuring apparatus which is disposed on the inlet side of the conveying device. The lubricant flow can be monitored and set by a computer.

US 4 520 902 A discloses a lubricant impingement system having a lubricant reservoir, a pump driven in a motorized manner, and a plurality of conveying devices, wherein the plurality of conveying devices are connected among one another and to the pump and to the lubricant reservoir by way of a common line for the lubricant. The common line functions both for supplying the lubricant that is to be dispensed by the conveying devices as well as for returning non-consumed lubricant. As a hydraulic fluid, the lubricant pressurized by the pump simultaneously drives the movable pistons of the individual conveying devices.

### SUMMARY OF THE INVENTION

It is an object of the invention to provide a metering device having improved metering.

The object is achieved by a metering device of the type mentioned above. The metering device according to the invention comprises a plurality of conveying devices each having one cavity for receiving the fluid and one piston for displacing the fluid. The plurality of conveying devices on the inlet side are in each case connected to the common supply line and on the outlet side are in each case connected to one of the plurality of discharge lines.

The metering device preferably comprises a drive unit. At least two of the conveying devices can be connected to the drive unit. Furthermore, the drive unit can drive at least two of the conveying devices. The drive unit is advantageously a common drive unit. The plurality of conveying devices are expediently mechanically connected to the common drive unit. It is moreover purposeful for the common drive unit to drive the plurality of conveying devices. In particular, the plurality of conveying devices can be driven/moved in a synchronous manner, for example while using the common drive unit.

The invention proceeds from the concept that a single pump as has been used to date can only inaccurately meter the required quantities of fluid. More fluid than necessary is typically consumed by way of such a pump in particular in the case of small required quantities.

On account of the plurality of conveying devices the fluid quantity is now split among the plurality of conveying devices. Each of the plurality of conveying devices has a cavity volume that is smaller than the aforementioned pump. The maximum volume of the respective cavity can be considered the cavity volume. By virtue of the smaller cavity volume each conveying device can measure a required quantity better than the afore-mentioned pump. Each of the conveying devices can convey a specific volumetric flow which then can be dispensed by the respective discharge line. Improved metering, in particular a more precise metering, can be guaranteed in this way. Moreover, the operating costs can be lowered by virtue of the improved metering.

The plurality of conveying devices furthermore enable a variable volumetric flow of fluid in a wide range. That volume of fluid which can be conveyed by a respective conveying device can be understood to be the volumetric flow. In particular, the volumetric flow which can be conveyed by one of the conveying devices can for example be at least 1 ml/min and/or at most 100 l/min, in particular at most 14 l/min. The volumetric flow can depend, for example, on the respective construction mode of the conveying device, in particular on a diameter of the conveying device, and/or on a drive speed.

At least one, in particular each, of the conveying devices can have an angular cross section. At least one, in particular each, of the conveying devices expediently has a round cross section. At least one, in particular each, of the conveying devices is preferably cylindrical. At least one, in particular each, of the conveying devices is (in each case) preferably embodied as a metering cylinder. At least one, in particular each, of the conveying devices can (in each case) be a piston pump, for example. Furthermore, at least one, in particular each, of the conveying devices can (in each case) have one piston, for example. Furthermore, the respective cavity which each of the conveying devices comprises can at least be a cylindrical chamber.

In one preferred design embodiment of the invention, the plurality of conveying devices are identically configured. Alternatively, the plurality of conveying devices can at least in part differ from one another, for example in terms of the cross-sectional area thereof, in terms of the cavity volume thereof, and/or in terms of other properties.

The common supply line advantageously opens into the plurality of conveying devices. Furthermore, each of the discharge lines can open into a respective discharge.

It is expedient for at least two of the conveying devices, in particular all conveying devices, to be intercoupled. For example, the intercoupled conveying devices can be coupled by way of a coupling unit.

Two elements can be understood to be “intercoupled” when the two elements are in interaction with each other. Furthermore, in the case of two (inter)coupled elements, the state of the one element can influence the state of the other element.

The metering device can furthermore comprise at least one linear guide by which the coupling element is expediently guided. In this way, the linear guide can have a mechanically stabilizing effect.

It is furthermore advantageous for at least two of the conveying devices, in particular all conveying devices, to be mechanically interconnected/connected among one another by way of a mechanical connection. The mechanical connection is expediently a rigid mechanical connection. The mechanical connection can be established by way of the coupling unit, for example.

The drive unit can comprise a linear drive. The linear drive can convert a rotary movement to a linear movement, for example. The drive unit can furthermore be a hydraulic, electric, and/or pneumatic drive unit. The drive unit can moreover have a gearbox or be free of any gearing.

A sensor can be disposed on the drive unit and/or on the mechanical connection, in particular on the coupling unit. The sensor can furthermore be integrated in the drive unit. The sensor can be a position sensor and/or a rotation speed sensor, for example. A drive speed of the driving unit, a speed of the piston, and/or a momentary volumetric flow can be determined with the aid of the sensor, for example.

At least one of the conveying devices can be embodied as a single-action metering cylinder. In one advantageous design embodiment of the invention, each of the conveying devices is in each case embodied as a single-action metering cylinder. Each of the single-action metering cylinders expediently comprises a single cylinder chamber which, in particular successively, can receive and discharge the fluid.

Furthermore, at least one of the conveying devices can be embodied as a double-action metering cylinder. In one preferred design embodiment of the invention, each of the conveying devices is in each case embodied as a double-action metering cylinder. Each of the double-action metering cylinders expediently comprises two cylinder chambers. While the first cylinder chamber of a respective double-action metering cylinder can receive the fluid, the second cylinder chamber of the same metering cylinder can preferably, in particular simultaneously, discharge the fluid, and/or vice versa. A double-action metering cylinder can be, for example, a double-rod cylinder, also referred to as a synchronous cylinder, or a differential cylinder.

At least one of the conveying devices, in particular each of the conveying devices, can have a leakage bore, in particular for identifying any leakage. Moreover, the metering device can comprise a collector line. Furthermore, the at least one conveying device, in particular each of the conveying devices, can be connected to the collector line by way of the respective leakage bore.

The metering device can comprise a return line, in particular a common return line. Moreover, the metering device can comprise at least one pressure control valve, in particular a plurality of pressure control valves. The metering device can furthermore comprise at least one switch valve, in particular a plurality of switch valves. One of the switch valves can in each case be disposed in each discharge line, for example.

At least one of the conveying installations is expediently connected to the return line. In particular, each of the conveying devices can be connected to the return line. Furthermore, each of the conveying devices can in each case be connected to the return line by way of one of the plurality of pressure control valves and/or by way of one of the plurality of switch valves.

Each of the switch valves can comprise in each case two positions, for example. The first position can be a passing position at which the respective conveying device is expediently connected to the respective discharge of the metering device. The second position can be a return flow position at which the respective conveying device is expediently connected to the return line.

The metering device can furthermore comprise a check unit. The switch valves can be connected to the check unit. Furthermore, the switch valves can be actuated and/or switched while using the check unit.

The metering device can have at least one check valve. The metering device expediently has a plurality of check valves. At least one of the plurality of check valves can in each case be disposed on the inlet side and/or on the outlet side of a respective conveying device.

The metering device preferably comprises at least one measuring coupling, also referred to as a mini measuring connector. The metering device can furthermore comprise at least one measuring sensor. The measuring coupling and/or the measuring sensor can be disposed in at least one of the plurality of discharge lines. The measuring sensor can be, for example, a pressure sensor, a temperature sensor, and/or a volumetric flow sensor.

The metering device comprises in particular a plurality of measuring couplings and/or a plurality of measuring sensors. At least one of the plurality of measuring couplings and/or at least one of the plurality of measuring sensors can be disposed in at least one of the plurality of discharge lines. At least one of the plurality of measuring couplings and/or at least one of the plurality of measuring sensors are/is preferably disposed in each of the plurality of discharge lines. For example, at least one of the plurality of measuring sensors, in particular each of the measuring sensors, can (in each case) be a pressure sensor, temperature sensor, and/or volumetric flow sensor.

The metering device can comprise a check unit and/or a controller unit, in particular for monitoring and/or controlling a parameter of the outgoing fluid.

The controller can be at least a controller without feedback, in particular a controller with feedback. The outgoing fluid is expediently the fluid going out by way of at least one of the discharge lines. The parameter can be, for example, a pressure, temperature, and/or a volumetric flow.

The check unit and/or the controller unit are/is expediently connected to at least one of the measuring sensors.

Furthermore, the check unit and/or the controller unit can be connected to each of the measuring sensors.

Moreover, the check unit and/or the controller unit can be connected to the aforementioned sensor. For example, the check unit and/or the controller unit can monitor the drive speed of the drive unit, the speed of a piston/the pistons, and/or a determined volumetric flow, in particular while using the sensor.

The check unit and/or the controller unit can furthermore be connected to the drive unit, in particular for controlling a drive speed of the drive unit. The check unit and/or the controller unit can comprise the above-mentioned check unit, or be a unit that is separate from the check unit.

The check unit and/or the controller unit can furthermore operate at least in a partially automatic manner. In the case of partially automatic monitoring and/or controlling, a part-step of monitoring and/or controlling can be carried out other than by the check unit and/or the controller unit per se, for example by a person in charge. Furthermore, monitoring and/or controlling can be carried out fully automatically by means of the check unit and/or the controller unit, in particular without any manual intervention by a person.

In one advantageous design embodiment of the invention, the metering device comprises a material block. A material block can be understood to be a block of solid material. The material block can have a plurality of bores and/or clearances. The plurality of conveying devices are in each case at least partially expediently disposed in the material block, in particular in the bores and/or clearances of the material block. Moreover, the pressure control valves, the switch valves, the check valves, the measuring coupling, the sensors, and/or further elements can at least partially be disposed in the material block and/or on the material block.

The material block can enable compact and/or robust construction mode of the metering devices. Lines or ducts, respectively, between the individual components can be kept short on account of the construction mode. Sealing locations can thus be reduced and/or avoided. Moreover, leakages can be reduced and/or avoided in this way.

The invention is furthermore directed toward a metering system having the metering device according to the invention, in particular having one of the refinements of the metering device described above.

The metering system expediently comprises a pump unit. The pump unit can have an initial pressure pump. The pump unit on the discharge side is preferably connected to the supply line. Moreover, the pump unit on the entry side can be connected to the return line.

It is furthermore advantageous for the metering system to comprise a fluid tank. The fluid tank on the discharge side in a purposeful manner is connected to the pump unit. The fluid tank on the entry side can furthermore be connected to the pump unit. The pump unit can comprise a pressure control valve.

The metering system can furthermore comprise a spray device, in particular having a plurality of nozzles.

The fluid can be a lubricant, for example.

The metering device and/or the metering system can in particular be a metering device/a metering system in rolling mill. Issues relating to grip by virtue of insufficient friction in a rolling gap of the rolling mill can be avoided by virtue of the improved metering.

The invention furthermore relates to a method for metering a fluid, wherein a metering device comprises a common supply line and a plurality of discharge lines, in which method the fluid is supplied by way of the common supply line and is dispensed by way of the plurality of discharge lines.

In order for improved metering to be enabled, the metering device according to the invention comprises a plurality of conveying devices having in each case one cavity and one piston, and the fluid in the case of the method is supplied to the plurality of conveying devices, wherein the cavities of the plurality of conveying devices receive the fluid, and each of the conveying devices dispenses a predetermined volumetric flow to, in each case, one of a plurality of discharge lines, wherein the pistons of the plurality of conveying devices displace the fluid.

The fluid when being displaced can in particular be dispensed from the plurality of conveying devices.

The metering device mentioned in the context of the method can in particular be the above-described metering device. Consequently, the elements mentioned hereunder of the metering device can be the aforementioned elements.

The plurality of conveying devices are expediently mechanically interconnected/connected among one another. It is furthermore preferable for the plurality of conveying devices to be driven in a common manner. In particular, the plurality of conveying devices can be driven and/or moved in a synchronous manner.

For example, the volumetric flow can be set in temporal terms in particular for metering the fluid.

The volumetric flow preferably is at least 1 ml/min. It is furthermore advantageous for the volumetric flow to be at most 100 l/min, in particular at most 14 l/min.

Furthermore, a spatial spray profile can be set, for example, by way of the choice of the conveying devices, in particular of the cavity volume thereof, by the switching mode of the conveying devices with the discharge lines and/or with a spray device and/or by the disposal of nozzles in the spray device.

In one preferred design embodiment of the invention, receiving of the fluid and displacing of the fluid take place successively. “Successively” can be understood to be in direct succession and/or by way of a temporal spacing. Each of the conveying devices can be designed in each case as a single-action metering cylinder having in each case a single cylindrical chamber, for example. Displacing can take place at the same speed as receiving, for example, and can take place up to 280 times more slowly than receiving. The design embodiment of the plurality of conveying devices as in each case a single-action metering cylinder can be particularly cost-effective.

In one further advantageous design embodiment of the invention, receiving the fluid and displacing the fluid take place simultaneously. In this case, each of the conveying devices can be designed as a double-action metering cylinder having in each case two cylinder chambers, for example. In particular, receiving the fluid and displacing the fluid take place simultaneously in different cylinder chambers of a respective conveying device, in particular in the different cylinder chambers of a respective double-action metering cylinder. For example, the first cylinder chamber of a respective double-action metering cylinder can receive the fluid, and the second cylinder chamber of the same metering cylinder can simultaneously displace the fluid, and vice versa. Continuous metering becomes possible in this way.

The previously provided description of advantageous embodiments of the invention contains numerous features, which in the individual dependent claims partially are presented combined as a plurality of features. Said features can however expediently also be considered individually and can be combined to form further purposeful combinations. In particular, said features can each be combined individually and in any arbitrary suitable combination with the method according to the invention and the metering device according to the invention, or the metering system according to the invention, respectively. Thus, method features may also be regarded as worded in substantive terms as properties of the corresponding device unit and vice versa.

Even though some terms are used in each case in the singular or in combination with a numeral in the description or in the claims, the scope of the invention is not intended to be limited to the singular or the respective numeral for these terms.

The properties, features and advantages of the invention described above and the manner in which they are achieved will be more clearly and distinctly comprehensible in conjunction with the following description of the exemplary embodiments, which are explained in greater detail in conjunction with the drawings. The exemplary embodiments are used to explain the invention and do not restrict the invention to the combination of features, including functional features, that is specified therein. For this purpose, it is furthermore also possible for suitable features of each exemplary embodiment to be considered explicitly in isolation, removed from one exemplary embodiment, introduced into another exemplary embodiment in order to supplement the latter and combined with any one of the claims.

### BRIEF DESCRIPTION OF THE DRAWINGS

In the drawings:

FIG. 1 shows a circuit diagram of a metering system;

FIG. 2 shows a circuit diagram of a metering device;

FIG. 3 shows an exemplary design embodiment of the metering device from FIG. 2;

FIG. 4 shows the exemplary design embodiment of the metering device from FIG. 3 in another perspective;

FIG. 5 shows a sectional view of the metering device from FIG. 3 and FIG. 4;

FIG. 6 shows a schematic longitudinal section through one of the conveying devices from FIG. 2 to FIG. 4;

FIG. 7 shows a schematic longitudinal section through an alternative design embodiment of the conveying devices;

FIG. 8 shows a circuit diagram of another metering system;

FIG. 9 shows a circuit diagram of another metering device;

FIG. 10 shows a schematic longitudinal section through one of the conveying devices from FIG. 8; and

FIG. 11 shows a circuit diagram of a further metering system.

### DESCRIPTION OF EMBODIMENTS

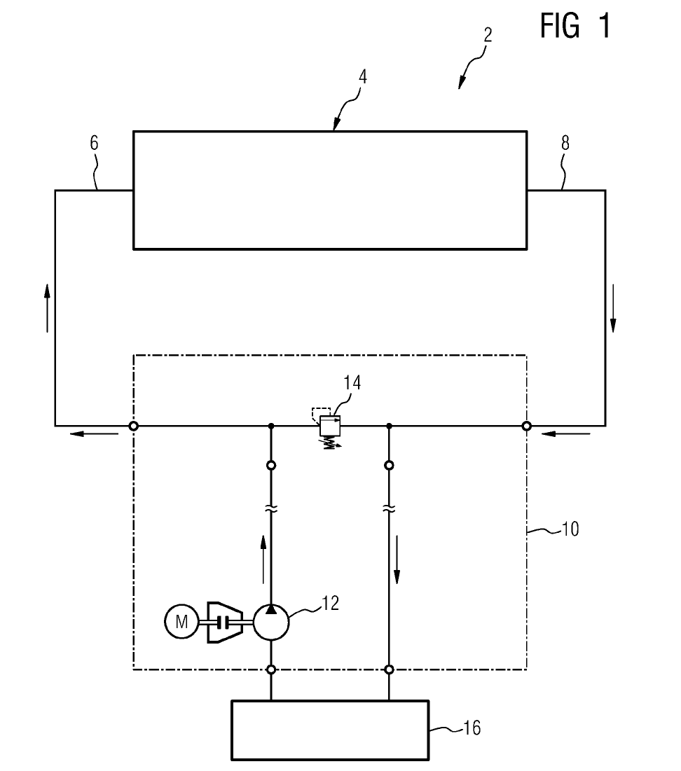

FIG. 1 shows a schematic circuit diagram of a metering system 2. The metering system 2 has a metering device 4, having a supply line 6 and a return line 8, for metering a fluid. The metering system 2 furthermore comprises a pump unit 10 which on the discharge side is connected to the supply line 6 and on the entry side is connected to the return line 8. The pump unit 10 comprises an initial pressure pump 12 as well as a pressure control valve 14.

The metering system 2 moreover comprises a fluid tank 16 which on the discharge side as well as on the entry side is connected to the pump unit 10.

The fluid tank 16 as well as the pump unit 10 supply the metering device 4 with fluid. For example, the fluid on the discharge side of the initial pressure pump 12 of the pump unit 10 is pressurized to approx. 1 bar to 3 bar.

The metering system furthermore can comprise a spray device (not illustrated) (cf. FIG. 11).

The metering system 2 in this exemplary embodiment is a metering system 2 in a rolling mill. The fluid is in particular a lubricant, in particular for lubricating rollers of the rolling mill and/or of a rolling gap of the rolling mill. For example, the rolling mill can be a rolling mill for hot rolling and/or cold rolling.

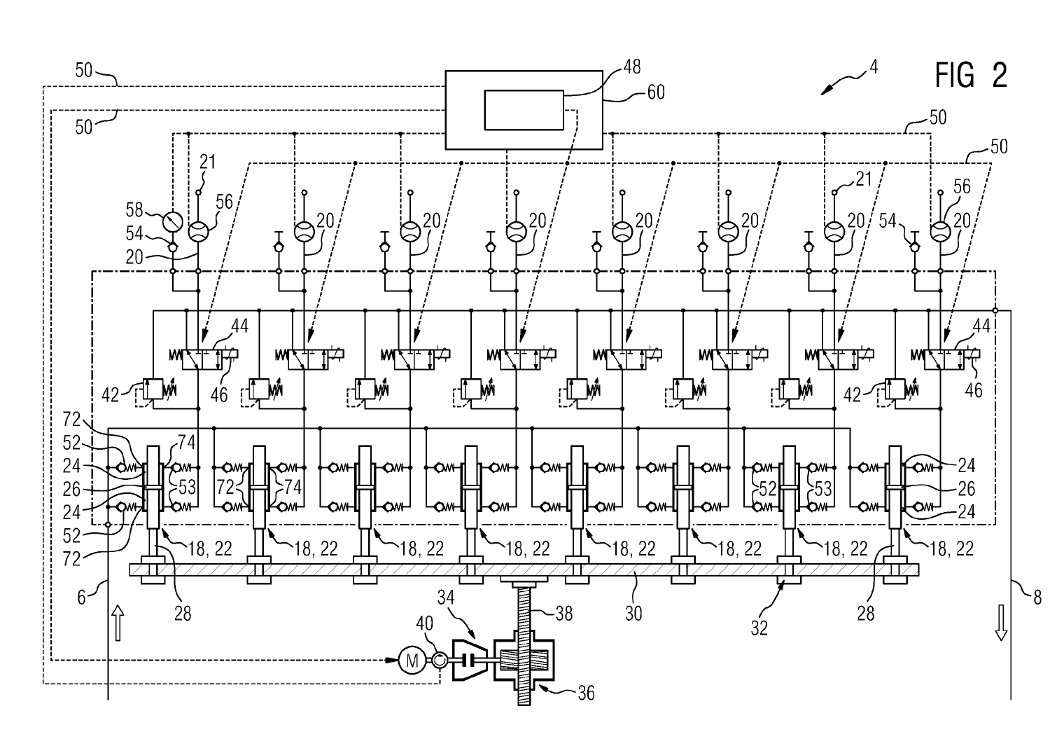

FIG. 2 shows a circuit diagram of the metering device 4 from FIG. 1. The metering device 4 comprises a plurality of conveying devices 18. The supply line 6 is a common supply line 6.

The plurality of conveying devices 18 on the inlet side are in each case connected to the common supply line 6. In particular, the common supply line 6 opens into the plurality of conveying devices 18.

The metering device 4 furthermore comprises a plurality of discharge lines 20. Each of the discharge lines opens into a discharge 21. One of the plurality of conveying devices 18 on the discharge side is in each case connected in each case to one of the plurality of discharge lines 20.

Each of the conveying devices 18 has a round cross section and is cylindrical. Each of the conveying devices 18 is in each case furthermore embodied as a metering cylinder. Moreover, each of the conveying devices 18 is in each case a piston pump.

The plurality of conveying devices 18 are of identical configuration and have an identical cross-sectional area and an identical cavity volume.

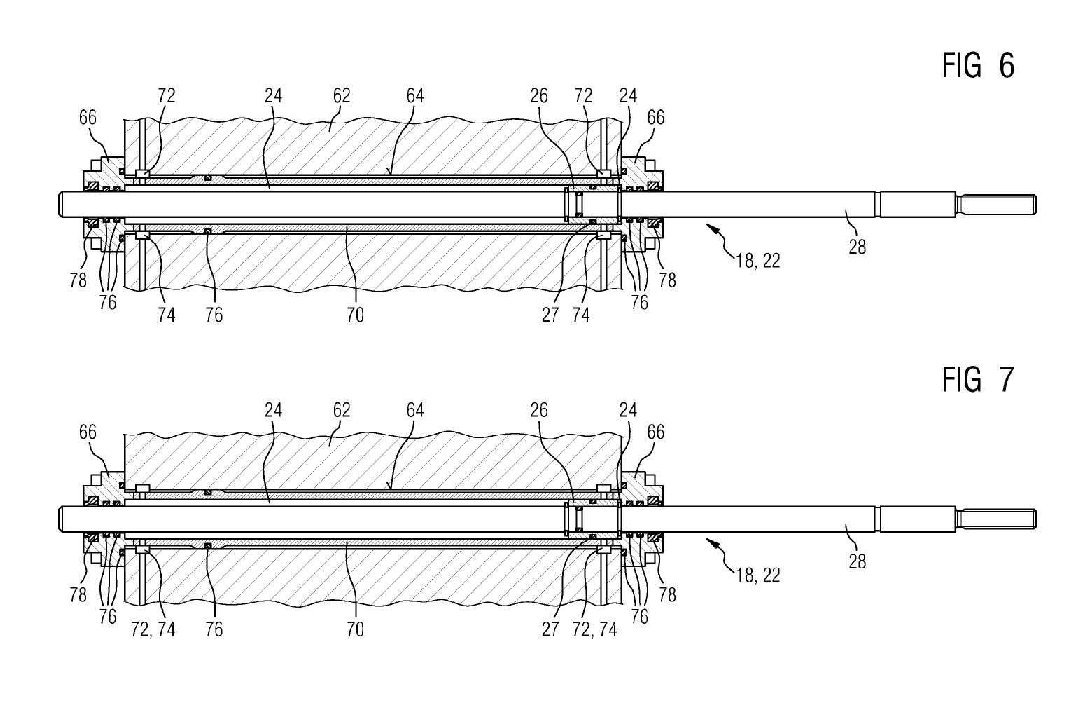

Each of the conveying devices 18 is in each case embodied as a double-action metering cylinder 22 (cf. FIG. 6). Each of the double-action metering cylinders 22 comprises two cylinder chambers 24. The two cylinder chambers 24 form the cavity of the respective double-action metering cylinder 22. Each of the double-action metering cylinders 22 furthermore comprises in each case one piston 26 which delimits the respective first cylinder chamber 24 in relation to the respective second cylinder chamber 24. Each of the pistons 26 has a piston seal 27.

Each of the double-action metering cylinders 22 is configured as a double-rod cylinder, also referred to as a synchronous cylinder. Moreover, each of the double-action metering cylinders 22 (cf. FIG. 6) has a continuous piston rod 28. The piston 26 is fixedly connected to the piston rod 28.

The plurality of conveying devices 18 (that is all of the latter) are furthermore intercoupled, in particular by way of a coupling unit 30. The coupling unit 30 is embodied as a coupling plate.

The plurality of conveying devices 18 (that is all of the latter) are in particular mechanically interconnected/connected among one another by way of a rigid mechanical connection 32. The mechanical connection 32 is established by way of the coupling unit 30.

The metering device 4 moreover comprises a drive unit 34 which is embodied as a common drive unit 34.

The plurality of conveying devices 18 are mechanically connected to the drive unit 34. The drive unit 34 drives the plurality of conveying devices 18 in a synchronous manner. In particular, the piston rod 28 by the drive unit 34 is in each case driven or moved, respectively, conjointly with the piston 26.

The drive unit 34 comprises a linear drive 36 which can convert a rotary movement to a linear movement. The drive unit 34 furthermore has a shaft 38 which is embodied as a spindle. The drive unit 34 by way of the shaft 38 is mechanically connected to the coupling unit 30.

A sensor 40 is integrated in the drive unit 34. The sensor 40 is configured as a rotation speed sensor. A drive speed of the drive unit 34 can first be determined with the aid of the sensor 40. Furthermore, a speed of one of the pistons 26, in particular of all pistons 26, and thus a momentary volumetric flow, can be determined with the aid of the sensor 40.

The metering device 4 moreover comprises a plurality of pressure control valves 42. The return line 8 is a common return line 8. Each of the conveying devices 18 by way of one of the plurality of pressure control valves 42 is connected to the return line 8. Should a pressure in one of the discharge lines 20 exceed a threshold value, the respective pressure control valve 42 ensures that the fluid can run off by way of the return line 8.

Fluid which is dispensed by/conveyed out of the respective conveying device 18 but is not dispensed by way of the respective discharge line 20 is returned to the pump unit by the common return line 8.

The metering device 4 furthermore comprises a plurality of switch valves 44. For example, one of the switch valves 44 is in each case disposed in each discharge line 20. Each of the switch valves 44 has an electric solenoid 46 by which the respective switch valve 44 is switched.

Each of the switch valves 44 in each case has two positions. The first position of the switch valve 44 is a passing position at which the respective conveying device 18 is connected to the respective discharge 21 of the metering device 4. The second position of the switch valve 44 is a return flow position at which the respective conveying device 18 is connected to the return line 8. Accordingly, each of the conveying devices 18 by way of the respective switch valve 44, and depending on the position of the respective switch valve 44 can be connected to the return line 8.

The metering device 4 furthermore comprises a check unit 48 which is connected to the plurality of switch valves 44 by a data connection 50. The data connection 50 can be established by a cable and/or in a wireless manner. The switch valves 44 are actuated and/or switched while using the check unit 48.

When rolling a wide strip, for example, all switch valves 44 can be at the passing position. Furthermore, when rolling a narrow strip, for example, the switch valves 44 that are located on the right and the left according to the drawing can be moved to the return flow position, while the switch valves 44 that are disposed in the center according to the drawing are at a passing position. Moreover, in the event of maintenance of the rolling mill and/or in the event of maintenance of the metering device, for example, all switch valves can be moved to the return flow position.

The metering device 4 has a plurality of check valves 52 which are in each case disposed on the inlet side or on the outlet side of a respective conveying device 18.

The metering device 4 furthermore comprises a plurality of measuring couplings 54 and a plurality of measuring sensors 56. One of the plurality of measuring couplings 54 and one of the plurality of measuring sensors 56 are in each case disposed in each of the plurality of discharge lines 20. Each of the measuring sensors 56 is in each case a volumetric flow sensor, for example. Furthermore, a further measuring sensor 58 which is a pressure sensor and/or a temperature sensor, for example, is disposed on/connected to one of the measuring couplings 54. In principle, a further measuring sensor 58 can in each case be disposed on each of the measuring couplings 54.

The metering device 4 comprises a controller unit 60 for monitoring and/or controlling a parameter of the outgoing fluid. The parameter can be a pressure, a temperature, and/or a volumetric flow, for example.

The controller unit 60 is connected to each of the volumetric flow sensors 56 by a data connection 50. In this way, the volumetric flow can be monitored at each of the discharge lines 20, in particular while using the controller unit 60. The controller unit 60 is furthermore connected to the drive unit 34 by a data connection 50, in particular for controlling a drive speed of the drive unit 34. The volumetric flow can be set or regulated, respectively, in this way.

The controller unit 60 is furthermore connected to the further measuring sensor 58 which is a pressure sensor and/or a temperature sensor. The pressure and/or the temperature at one of the discharge lines 20 can be monitored in this way, in particular while using the controller unit 60. A malfunction, for example an increase in pressure by virtue of clogging, and/or a drop in pressure by virtue of leaking, can be identified in a timely manner in this way.

The previously mentioned sensor 40 is also connected to the controller unit 60 by way of a data connection 50. The sensor measures the current rotations of the drive unit 34, or the drive speed of the drive unit 34, respectively. The rotations or drive speed are monitored by the control unit 60.

The controller unit 60 in this exemplary embodiment comprises the above-mentioned check unit 48 for setting the switch valves 44.

The width of a rolled strip which is to be rolled/is being rolled is known to the controller unit 60, or to the check unit 48, respectively. The switch valves are switched in a corresponding manner. Furthermore, a rolling speed is known to the controller unit 60, from which the controller unit 60 can draw a conclusion in terms of a required volumetric flow of fluid. A required drive speed of the drive unit 34 is calculated from the required volumetric flow. The controller unit 60 actuates the drive unit 34 in a corresponding manner. The drive speed set is verified and optionally readjusted by means of the sensor 40. If a volumetric flow that deviates from the required volumetric flow is measured by means of one of the volumetric flow sensors 56, the controller unit 60 in this instance can in turn readjust the drive speed of the drive unit 34.

The metering device 4 is used for rolling a continuous rolled strip, for example.

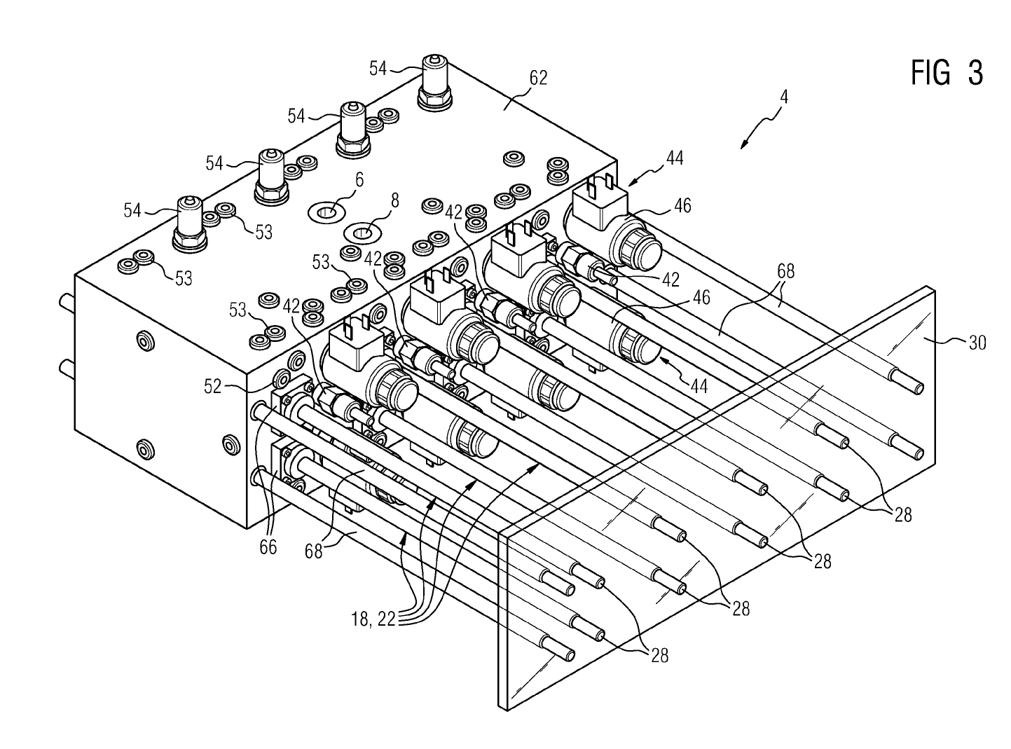

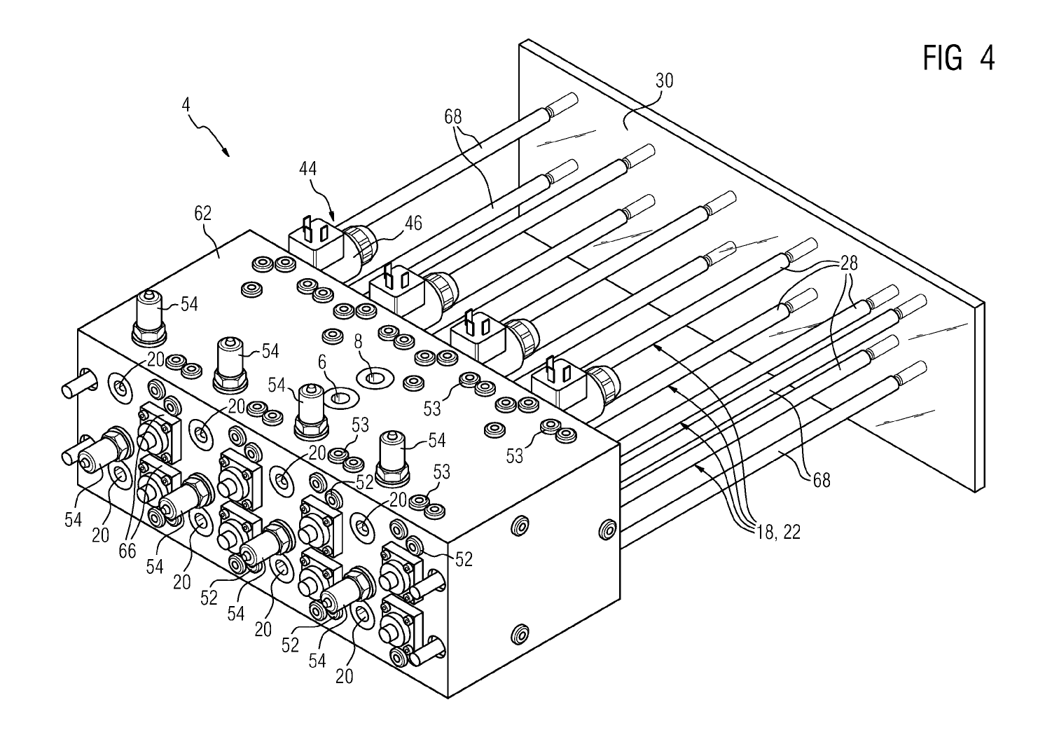

FIG. 3 schematically shows an exemplary design embodiment of the metering device 4 from FIG. 2. FIG. 4 shows the same exemplary design embodiment of the metering device 4 as in FIG. 3, but from another perspective.

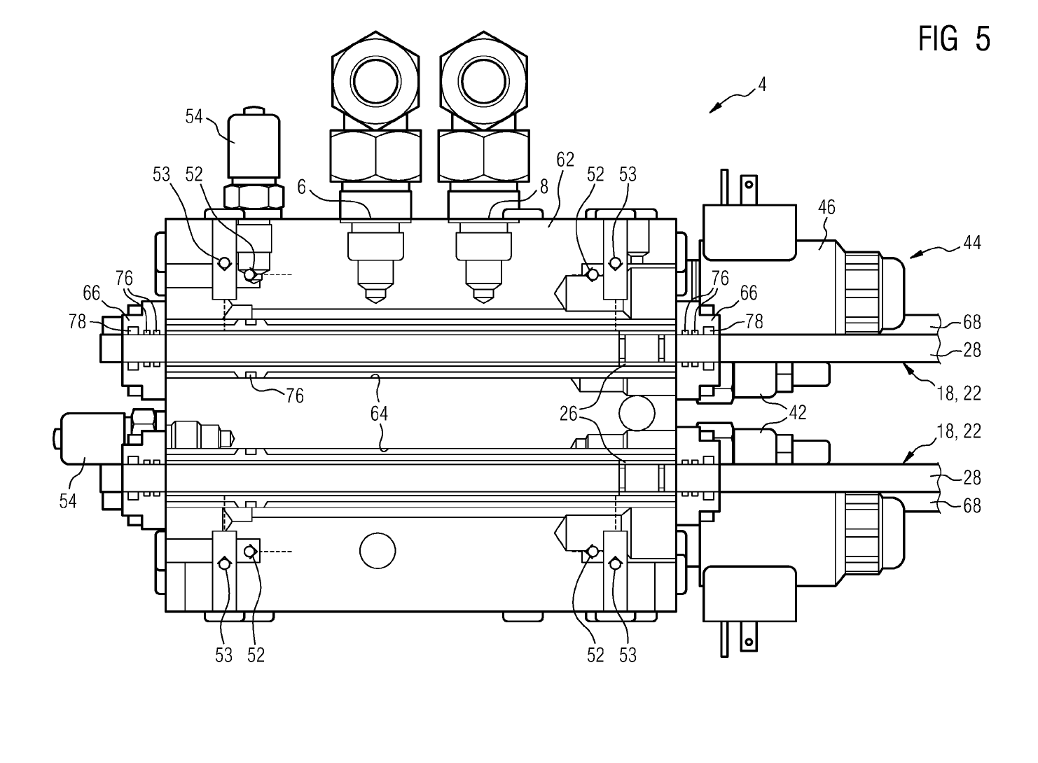

The metering device 4 in FIG. 3 and FIG. 4 comprises a material block 62. The material block is a block of solid material, for example of steel, in particular of stainless steel. The plurality of conveying devices 18 are in each case at least in part disposed in the material block 62. The material block 62 comprises in particular cylindrical bores 64 (cf. FIG. 5 and FIG. 6) which penetrate the material block 62. One of the conveying devices 18 is disposed in each of the bores 64.

Each of the conveying devices 18 furthermore comprises two fixing elements 66 which are in each case configured as a cylinder head. Each of the conveying devices 18 at both ends of the bore 64 is in each case fixed or held, respectively, by one of the fixing element 66. The fixing elements 66 are connected, in particular screw-fitted, to the material block 62. A simple and rapid replacement of the individual conveying devices 18 or of parts thereof is enabled in this way.

The material block 62 furthermore comprises clearances which are in each case configured as a blind bore. Moreover, the pressure control valves 42, the switch valves 44, the check valves 52, the measuring coupling 54, the measuring sensors 56 are at least in part disposed, for example screw-fitted, in the material block 62, in particular in the clearances.

The material block 62 is in this way configured as a cylinder and valve housing.

The material block 62 enables a compact and robust construction mode of the metering device 4. Lines or ducts, respectively, between individual components are embodied by bores in the material block 62, and on account of this construction mode, are kept short such that leakages can be reduced and/or avoided.

The metering device 4 furthermore comprises linear guides 68. The coupling unit 30 is guided with the aid of the linear guides 68. The linear guides 68 increase the mechanical stability of the metering device 4 in this way.

The coupling unit in FIG. 3 and FIG. 4 is illustrated so as to be transparent in order for the linear guides 68 and the piston rods 28 to be better visible.

The material block 62 having the bores 64 and clearances thereof can be manufactured in a cost-effective and automated manner.

FIG. 5 shows a section through the metering device 4 from FIG. 3 and FIG. 4 along two conveying devices 18.

The material block 62 in this image is illustrated so as to be transparent. Furthermore, hatching of the sectioned elements has been dispensed with for the sake of better clarity.

The cylindrical bores 64 which penetrate the material block 62 can be seen in this image. One of the conveying devices 18 is disposed in each of said bores 64.

It can be further seen in this image that the pressure control valves 42, the switch valves 44, check valves 52, and the measuring coupling 54 are at least in part disposed in the material block 62, in particular in the clearances which are in each case configured as a blind bore.

The check valves 52 are disposed completely in the material block 62. In the case of the switch valves 44, a part, in particular the electrical part (solenoid 46 and the electrical connector) of the switch valves protrudes from the material block 62. The pressure control valves 42 also protrude in part from the material block 62, in particular so as to be able to set the threshold value, or the switching time, respectively, of the pressure control valves 42. The measuring couplings 54 likewise protrude in part from the material block 62. A measuring sensor 58 (cf. FIG. 2) can thus be connected to the respective measuring coupling 54.

FIG. 6 shows a schematic longitudinal section through one of the conveying devices 18 from FIG. 2 to FIG. 5. The conveying device 18 is disposed in the cylindrical bore 64 which penetrates the material block 62.

The conveying device 18 is embodied as a double-action metering cylinder 22. The double-action metering cylinder furthermore comprises the piston rod 28 which is fixedly connected to the piston 26, and a cylinder tube 70 which forms the external wall. The piston 26 within the cylinder tube 70 moves in a reciprocating manner in the direction of the longitudinal axis of the cylinder tube 70. According to the drawing, the piston 26 within the cylinder tube 70 moves in the vertical direction toward the right and the left.

The double-action metering cylinder 22 comprises two cylinder chambers 24. The piston 26 separates the first cylinder chamber 24 from the second cylinder chamber 24. Each of the cylinder chambers by way of an inlet 72 is connected to the supply line 6, and by way of an outlet 74 is connected to the respective discharge line 20. While the first cylinder chamber 24 of the double-action metering cylinder 22 receives the fluid, the second cylinder chamber 24 of the same metering cylinder 22 simultaneously dispenses the fluid, and vice versa.

The conveying device 18 is fixed with the aid of the two fixing elements 66 (here cylinder heads). The fixing elements 66 are screw-fitted to the material block 62. Each of the fixing elements 66 furthermore comprises a plurality of seals 76 which are configured as annular seals. The seals guarantee a tightness of the conveying device 18. Moreover, each of the fixing elements 66 comprises a scraper 78. The respective scraper 78 is configured as a rubber ring. The scrapers 78 likewise ensure a tightness of the conveying device 18. The cylinder tube 70 also comprises a seal 76 which seals the fixing element 66 in relation to the material block 62.

In FIG. 6 the left cylinder chamber 24 according to the drawing, which represents the first cylinder chamber 24, is completely filled. Furthermore, the right cylinder chamber 24 according to the drawing, which represents the second cylinder chamber 24, is completely emptied. The piston 26 accordingly is located in the terminal position on the right according to the drawing. The piston rod 28, conjointly with the piston 26, is subsequently moved by the drive unit toward the left according to the drawing, such that the left, first cylinder chamber 24 of the double-action metering cylinder dispenses the fluid by way of the left outlet 74 according to the drawing. The right, second cylinder chamber 24 simultaneously receives the fluid by way of the right inlet 72 according to the drawing. The piston rod 28, conjointly with the piston 26, is thus moved to the left until the left, first cylinder chamber 24 is completely emptied and the right cylinder chamber is completely filled.

The piston rod 28, conjointly with the piston 26, then moves toward the right such that the left, first cylinder chamber 24 of the double-action metering cylinder receives the fluid by way of the left inlet 72 according to the drawing, and the right, second cylinder chamber 24 simultaneously dispenses the fluid by way of the right outlet 74 according to the drawing, until the left, first cylinder chamber 24 according to the drawing is completely filled, and the right, second cylinder chamber 24 according to the drawing is completely emptied. The procedure is repeated as a circulatory system. Continuous metering is possible in this way.

The piston 26 in an exemplary manner has an external diameter of 14 mm. The piston rod 28 in a furthermore exemplary manner has a diameter of 10 mm. The so-called stroke of the conveying device 18 is, for example, 160 mm. The distance which the piston 26 can cover at most in one direction can be referred to as the stroke. The cavity volume of the conveying device 18 is thus 12 ml, for example.

The fluid that is received by the respective cylinder chamber 24 is pressurized to 1 bar to 3 bar, for example. Furthermore, the fluid that is dispensed by the respective cylinder chamber is pressurized to 5 bar to 10 bar, for example. The threshold value of the check valves 52 is adapted to the pressure conditions of the fluid in a corresponding manner. Accordingly, the respective check valve 52 that is disposed on the outlet side of the respective cylinder chamber 24 has a higher threshold value than the respective check valve 52 that is disposed on the inlet side of the respective cylinder chamber 24.

The volumetric flow which can in each case be conveyed by a conveying device 18 (hereunder simply referred to as “the volumetric flow”) in this exemplary embodiment corresponds to the volumetric flow which in each case can be dispensed by way of one of the discharge lines 20. The volumetric flow can be set so as to depend on the drive speed of the drive unit 34. For example, the volumetric flow can be set in a range from 3.5 ml/min to 64 ml/min.

FIG. 7 shows a schematic longitudinal section through an alternative design embodiment of the conveying devices 18 from FIG. 6. The description hereunder is substantially limited to the points of differentiation in relation to the conveying devices 18 from FIG. 6, to which reference is made in terms of features and functions that remain the same. Elements that substantially remain the same are in principle identified by the same reference signs, and features which are not mentioned are incorporated in the following exemplary embodiment without being described once again.

Each of the cylinder chambers 24 has an inlet 72 which simultaneously functions as an outlet 74.

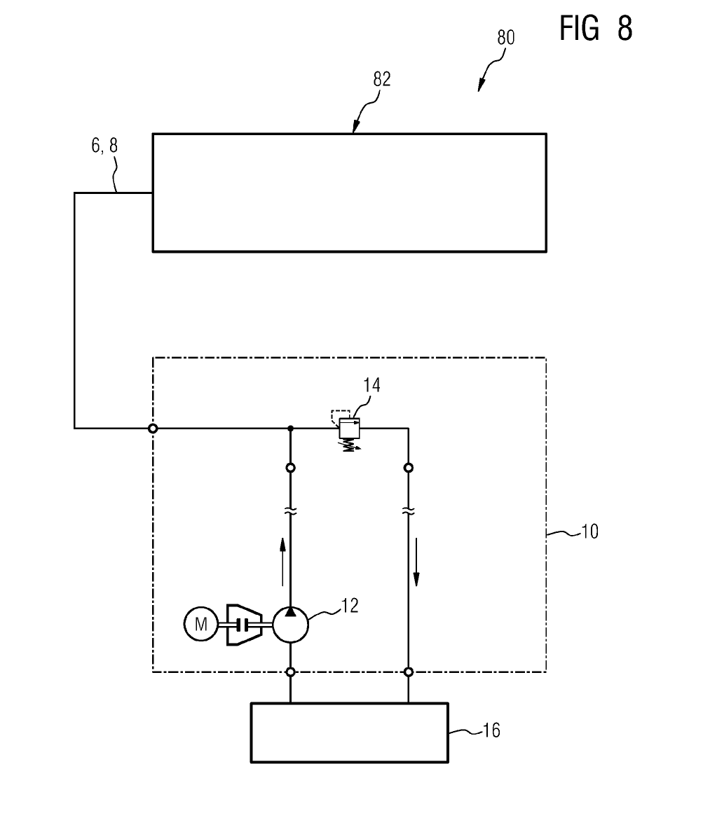

FIG. 8 shows a schematic circuit diagram of a further metering system 80 having another metering device 82 for metering a fluid. The description hereunder is substantially limited to the points of differentiation in relation to the exemplary embodiment from FIG. 1 to FIG. 6, reference being made to the latter in terms of features and functions that remain the same. Elements that substantially remain the same are in principle identified by the same reference signs, and features which are not mentioned are incorporated in the following exemplary embodiment without being described once again.

The supply line 6 of the metering device 82 simultaneously functions as a return line 8. In principle, a design embodiment in which the supply line 6 and the return line 8 are present so as to be separate from one another (in a manner analogous to that of the first exemplary embodiment) would in principle also be possible.

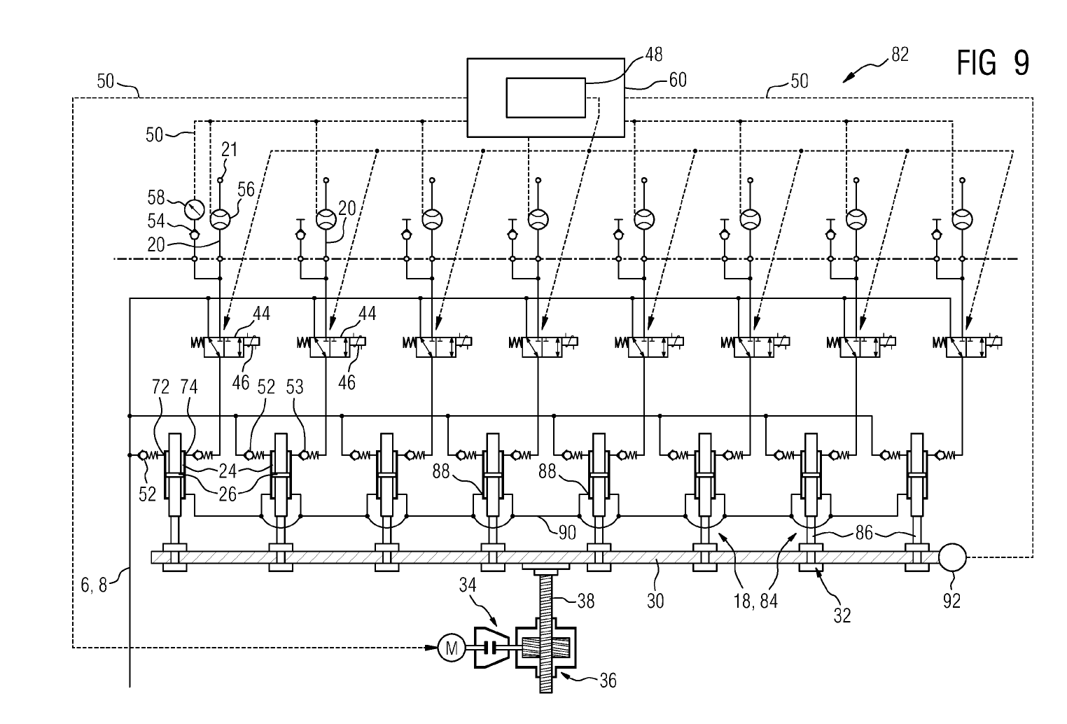

FIG. 9 shows a circuit diagram of the metering device 82 from FIG. 8.

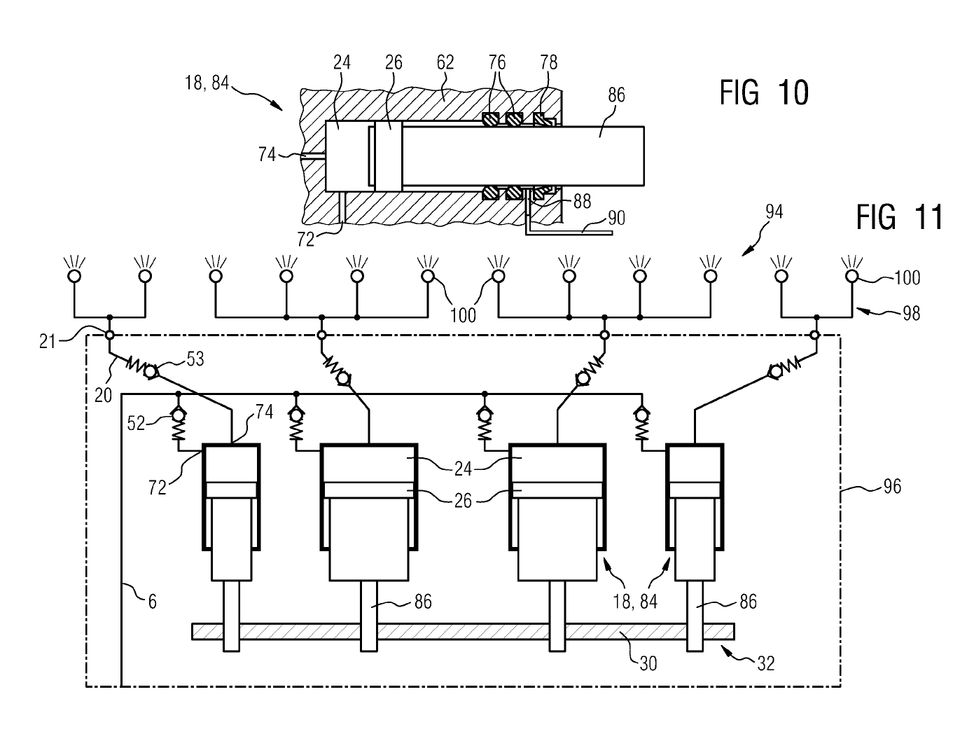

Each of the conveying devices 18 is in each case embodied as a single-action metering cylinder 84 (cf. FIG. 10). Each of the single-action metering cylinders 84 expediently comprises a single cylinder chamber 24. Each of the single-action metering cylinders 84 furthermore comprises in each case one piston 26 and one piston rod 86. The piston 26 is fixedly connected to the piston rod 86, wherein the piston rod 86 is located only on one side of the piston 26.

Each of the conveying devices 18 has one leakage bore 88. The metering device 82 furthermore comprises a collector line 90 which is connected to the leakage bores 88.

A sensor 92 is disposed on the mechanical connection 32, in particular on the coupling unit 30 (instead of the sensor 40 on the drive unit 34 in the first exemplary embodiment). The sensor 92 is a position sensor. The sensor 92 can determine the position of the coupling unit 30 and thus the speed of the coupling unit 30 or the speed of the pistons 26, respectively, and/or the volumetric flow.

The sensor 92 is also connected to the controller unit 60 by way of a data connection 50. The sensor 92 measures the position of the coupling unit 30 and thus the speed of the coupling unit 30, or the speed of the pistons 26, respectively, said speed being monitored by means of the control unit 60.

The metering device 82 in this exemplary embodiment does not comprise any pressure control valves (as opposed to the first exemplary embodiment in FIG. 1 to FIG. 6), although this would be possible in principle.

The metering device 82 is used in a hot-rolling process, for example, in particular for rolling individual rolled strips from slabs. If the respective conveying devices 18 are completely filled with fluid, the quantity of fluid is sufficient for an entire rolled strip. The filling of the conveying devices 18 in this instance can be performed between rolling a first strip and rolling a second strip, for example.

FIG. 10 shows a longitudinal section through one of the conveying devices 18 from FIG. 9. The conveying device 18 is embodied as a single-action metering cylinder 84 and comprises a single cylinder chamber 24. The cylinder chamber 24 forms the cavity of the single-action metering cylinder 84. The cylinder chamber 24 can successively receive and dispense the fluid.

The cylinder chamber 24 in FIG. 10 is partially filled. The piston 26 is located in the center according to the drawing.

The piston rod 86, conjointly with the piston 26, subsequently moves to the right such that the cylinder chamber 24 receives the fluid by way of the inlet 72 until the cylinder chamber 24 is completely filled.

The piston rod 86, conjointly with the piston 26, is subsequently moved by the drive unit to the left according to the drawing such that the cylinder chamber 24 dispenses the fluid by way of the outlet 74. The metering of the fluid is performed in this way. The piston rod 86, conjointly with the piston 26, can move to the left until the cylinder chamber 24 is completely emptied. The cylinder chamber 24 subsequently has to be refilled. The procedure is repeated as a circulatory system. Discontinuous metering is possible in this way.

The cylinder chamber 24 can be completely filled in 11 s, for example. Furthermore, the cylinder chamber is completely emptied in, for example, 11 s to 205 s, depending on the volumetric flow set.

The conveying device 18 has a leakage bore 88 for identifying leakages. Furthermore, the conveying device 18 is connected to the collector line 90 of the metering device 82 by way of the leakage bore 88.

In the event of a leakage from the conveying device 18, some fluid exits by way of the leakage bore 88. The fluid that has exited by virtue of the leakage accumulates in the collector line 90 and can be detected visually and/or by way of a measuring apparatus. In the event of a defect in one of the conveying devices 18, a timely replacement of the defective conveying device 18 can be guaranteed in this way.

FIG. 11 shows a further metering system 94 having a metering device 96. The description hereunder is substantially limited to the points of differentiation in relation to the exemplary embodiment from FIG. 8 to FIG. 10, reference being made to the latter in terms of features and functions that remain the same. Elements that substantially remain the same are in principle identified by the same reference signs, and features which are not mentioned are incorporated in the following exemplary embodiment without being described once again.

Some elements (such as, for example, a pump unit, a fluid tank, a drive unit, a return line, pressure control valves, switch valves, measuring couplings, measuring sensors, etc.) are not shown in FIG. 11 but could in principle be incorporated individually or in any arbitrary combination from the other exemplary applications.

The metering system 94 comprises a spray device 98 having a plurality of nozzles 100. The spray device 98 is furthermore connected to the plurality of discharge lines 20 of the metering device 96.

The metering device 96 comprises a plurality of conveying devices 18 which at least in part differ from one another, for example in terms of the cross-sectional area thereof and in terms of the cavity volume thereof. For example, the respective cross-sectional area and the respective cavity volume of the conveying devices 18 disposed on the right and on the left according to the drawing is smaller than in the conveying devices 18 disposed in the center according to the drawing. The cross-sectional areas of the conveying devices 18, or the different cavity volumes of the conveying devices 18, respectively, enable different volumetric flows.

Furthermore, more nozzles 100 of the spray device are connected to the conveying devices 18 that are disposed in the center according to the drawing than are connected to the conveying devices 18 that are disposed on the right and on the left according to the drawing.

A desired spatial spray profile can be set by way of a corresponding circuit design including the nozzles 100 and of a corresponding disposal of the nozzles 100.

Even though the invention has been illustrated and described in more detail by way of the preferred exemplary embodiments, the invention is not restricted by the examples disclosed, and other variations may be derived therefrom by a person skilled in the art without departing from the scope of protection of the invention.

### LIST OF REFERENCE SIGNS

2 Metering system

4 Metering device

6 Supply line

8 Return line

10 Pump unit

12 Initial pressure pump

14 Pressure control valve

16 Fluid tank

18 Conveying device

20 Discharge line

21 Discharge

22 Metering cylinder

24 Cylinder chamber

26 Piston

27 Piston seal

28 Piston rod

30 Coupling unit

32 Mechanical connection

34 Drive unit

36 Linear drive

38 Shaft

40 Sensor

42 Pressure control valve

44 Switch valve

46 Solenoid

48 Check unit

50 Data connection

52 Check valve

54 Measuring coupling

56 Measuring sensor

58 Measuring sensor

60 Controller unit

62 Material block

64 Bore

66 Fixing element (cylinder head)

68 Linear guides

70 Cylinder tube

72 Inlet

74 Outlet

76 Seal

78 Scraper

80 Metering system

82 Metering device

84 Metering cylinder

86 Piston rod

88 Leakage bore

90 Collector line

92 Sensor

94 Metering system

96 Metering device

98 Spray device

100 Nozzles

1. A metering device (4, 82, 96) for metering a fluid, comprising a common supply line (6) and a plurality of discharge lines (20),
characterized by
a plurality of conveying devices (18) having in each case one cavity (24) for receiving the fluid and one piston (26) for displacing the fluid, wherein the plurality of conveying devices (18) on the inlet side are in each case connected to the common supply line (6) and on the outlet side are in each case connected to one of the plurality of discharge lines (20).

2. The metering device (4, 82, 96) as claimed in claim 1,
characterized in that at least two of the conveying devices (18), in particular all conveying devices (18), are intercoupled.

3. The metering device (4, 82, 96) as claimed in claim 1 or 2,
characterized by a common drive unit (34), wherein the plurality of conveying devices (18) are mechanically connected to the common drive unit (34).

4. The metering device (4, 82, 96) as claimed in one of the preceding claims,
characterized in that each of the conveying devices (18) is in each case embodied as a single-action metering cylinder (84) and/or as a double-action metering cylinder (22).

5. The metering device (4, 82, 96) as claimed in one of the preceding claims,
characterized by a common return line (8) as well as a plurality of pressure control valves (42) and/or a plurality of switch valves (44), wherein each of the conveying devices (18) is in each case connected to the return line (8) by way of one of the plurality of pressure control valves (42) and/or by one of the plurality of switch valves (44).

6. The metering device (4, 82, 96) as claimed in one of the preceding claims,
characterized by a plurality of stop valves (52), wherein at least one of the plurality of stop valves (52) on the inlet side and/or the outlet side is in each case disposed on a respective conveying device (18).

7. The metering device (4, 82, 96) as claimed in one of the preceding claims,
characterized by at least one measuring coupling (54) and/or at least one measuring sensor (58), wherein the measuring coupling (54) and/or the measuring sensor (58) are/is disposed in at least one of the plurality of discharge lines (20).

8. The metering device (4, 82, 96) as claimed in one of the preceding claims,
characterized by a check unit and/or a controller unit (60) for monitoring and/or controlling a parameter of the outgoing fluid.

9. The metering device (4, 82, 96) as claimed in one of the preceding claims,
characterized by a material block (62), wherein the plurality of conveying devices (18) are in each case at least partially disposed in the material block (18).

10. A metering system (2, 80, 94) having a metering device (4, 82, 96) as claimed in one of the preceding claims,
characterized by a pump unit (10) which on the discharge side is connected to the supply line (6), and by a fluid tank (16) which on the discharge side is connected to the pump unit (10).

11. A method for metering a fluid, wherein a metering device (4, 82, 96) comprises a common supply line (6) and a plurality of discharge lines (20), in which method the fluid is supplied by way of the common supply line (6) and is dispensed by way of the plurality of discharge lines (20),
characterized in that
the metering device (4, 82, 96) comprises a plurality of conveying devices (18) having in each case one cavity (24) and one piston (26), in which method the fluid is supplied to the plurality of conveying devices (18), wherein the cavities (24) of the plurality of conveying devices (18) receive the fluid, and each of the conveying devices (18) dispenses a predetermined volumetric flow to in each case one of a plurality of discharge lines (18), wherein the pistons (26) of the plurality of conveying devices (18) displaces the fluid.

12. The method as claimed in claim 11,
characterized in that the plurality of conveying devices (18) are driven and/or moved in a synchronous manner.

13. The method as claimed in claim 11 or 12,
characterized in that the volumetric flow is at least 1 ml/min and at most 100 l/min.

14. The method as claimed in one of claims 11 to 13,
characterized in that receiving of the fluid and displacing of the fluid take place successively.

15. The method as claimed in one of claims 11 to 14,
characterized in that receiving of the fluid and displacing of the fluid take place simultaneously.
